(19) United States
(12) Patent Application Publication
(10) Pub. No.: US 2006/0246926 A1
(43) Pub. Date: Nov. 2, 2006

(54) Method and apparatus for combining enterprise IP-PBX and cellular mobile services

(76) Inventors: Kai Y. Eng, Atlantic Highlands, NJ (US); Pramod Pancha, Somerset, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/372,986

(22) Filed: Mar. 10, 2006

Related U.S. Application Data
(60) Provisional application No. 60/660,196, filed on Mar. 10, 2005.

(51) Int. Cl. H04Q 7/20; H04M 3/42; H04Q 7/38

(52) U.S. Cl. 455/465; 455/417; 455/414.1

(57) ABSTRACT

A method and apparatus that bridges a cell phone or similar wireless device that utilizes a public wireless network with a private enterprise PBX. A mobile server is connected to the IP-PBX, and acts as a proxy for the cell phone or similar wireless device, making it appear to the IP-PBX and associated internal enterprise network as if it were the internal phone or computer connected to the internal enterprise network.

### RELATED APPLICATION

This application claims the benefit of priority to US Provisional patent application number 60/660,196, filed Mar. 10, 2005. The provisional is incorporated fully herein by reference, and a copy of said provisional is attached hereto as appendix A.

### BACKGROUND OF THE INVENTION

Sophisticated private branch exchange (PBX) systems are well known and commonplace. Many have recently added Internet protocol (IP) capabilities.

IP-PBX systems are gaining market acceptance rapidly, and provide integrated voice and data services to users within a particular enterprise “campus.” For example, a company may have a PBX that connects both to the Internet and to the telephone network, and provides voice and data services within the enterprise campus. By “campus” we mean the network of the organization with whom a user is associated, such as his employer, as opposed to a public or commercially available network.

One problem with such systems is that the users, which could include hundreds or even thousands of employees of a large company, often have their own wireless cell phone and data access devices as well. These wireless access devices often operate on public cellular networks, which include their own features such as voicemail, instant messenger, etc. that are different than those functions as maintained by the enterprise network and IP-PBX. Not only can the functions be different, but even when the functions of the public network is the same or similar to that of the enterprise network, often the interface and/or means of invoking those functions are different. Accordingly, users are faced with two different user interfaces, and there is no integration between the IP-PBX and the functionality access by the public wireless service.

One example of this is voice mail. A voice mail system typically includes set of commands to perform common configuration functions such as setting passwords, changing greeting messages, deleting or saving messages, etc. There is no standard for implementing such functions, so a user might have to push 3# to delete a voice mail message on his cell phone, but 67# to delete a voice mail message on his office desktop telephone voice mail.

Other examples are that the cell phone typically has a different phone number from the desktop telephone set, a different set of stored voice messages, different conferencing capability, etc. In short, the cell phone and the office desk top telephone operate on different systems, with different but often overlapping functions, and different user interfaces.

In view of the foregoing, there exists a need for a single integrated system that can provide wireless voice and data access through the enterprise campus system not only when a user accesses the system via his desktop telephone, but when a user accesses the system via his cell phone or other wireless device via an unrelated and possibly public voice/data network.

### SUMMARY OF THE INVENTION

The above and other problems of the prior art are overcome in accordance with a method and apparatus for integrating the public cellular voice and data service into an enterprise campus private service, implemented by the IP-PBX and enterprise network. Communications between a mobile service and the wireless device preferably take place over a public voice and/or data network. A connection is made between a wireless device such as a cell phone, and a mobile server, which acts as a gateway between the IP-PBX of the enterprise, and the wireless device.

The wireless device can receive and dial calls as if it were a desktop phone with applicable IP-PBX functions such as one number appearance, voicemail, corporate directory, etc. Essentially, the mobile server acts as a proxy to make the wireless device look like the desktop telephone to the enterprise IP_PBX, and to users thereof.

### DESCRIPTION OF THE DRAWING

FIG. 1 shows a block diagram of an exemplary embodiment of the present invention.

### DETAILED DESCRIPTION OF THE PREFERRED EMBODIMENTS

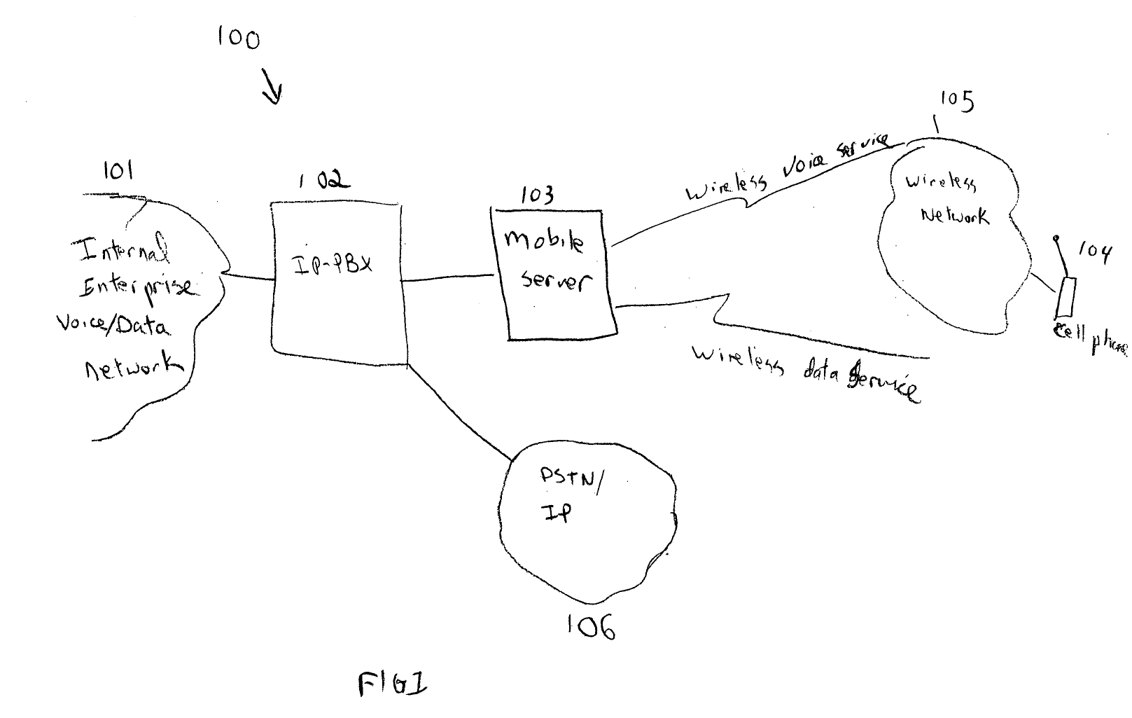

FIG. 1 shows an exemplary embodiment of the present invention including, in block diagram form, the basic components thereof. The system includes an internal enterprise voice and data network 101, a preferably IP enabled PBX 102, a mobile server 103, appropriate software (described later) and a wireless network 105, which may be any commercially available wireless network.

An exemplary cell phone 104 is shown, with the understanding that the invention is directed more generally to any wireless voice/data device. A network or set of networks 106 is intended to represent the Internet or similar data network, and the Public Switched Telephone Network (PSTN) to which the IP-PBX 102 interfaces.

The mobile server 103 and IP-PBX 102 may each include typical microprocessors and related components, input/output devices, and other standard hardware and software, much of which is not shown in FIG. 1.

A typical configuration of an IP-PBX 102 includes a variety of enterprise selected functions, such as enterprise voicemail, corporate directory service, conferencing, etc. The mobile server 103 acts as a gateway/interface to the public wireless network 105, and presents to the user of cell phone 104 an interface that provides the same functionality provided by IP-PBX 102 to the desktop phones within the enterprise voice and data network 101. The IP-PBX 102 is also connected to the PSTN 106 and/or public IP network as shown.

The wireless network 105 is typically operated by a commercial carrier, and is independent of the internal enterprise network 101. In accordance with the invention, in normal operation, the user of cell phone 104 need not distribute to others or normally even use the actual cell phone number assigned by his wireless network carrier. Instead, that number would be loaded and stored in mobile server 103 and/or IP-PBX 102.

When a call arrives at IP-PBX 102, for example, from the PSTN 106, that caller might be presented with a menu of options. Such menu might include a voice prompt which requests the extension of the called party, indicates the called party can be entered by name, etc. These features are those selected by the manufacturer of the IP-PBX 102 and/or by software selected by such manufacturer or by the enterprise purchasing the system.

After a caller selects the called party with whom to connect, the PBX 102 recognizes that such calls should be instead connected to cell phone 104. This recognition may be accomplished in any one or more of a variety of different manners. One example would be that the user of cell phone 104 could simply enter a code into the system to configure it for such recognition, either through the desktop telephone (not shown) or otherwise. This is similar to the manner in which users today may conventionally enter call forwarding instructions when leaving home.

Alternatively, a user of the cell phone may log in over the wireless network to the mobile server 103, and enter instructions indicating that calls to the particular desktop telephone associated with the user should be forwarded to a mobile server 103. Another implementation is for the IP-PBX 102 to treat the cell phone 104 and desktop telephone as two different handsets connected to the same extension, forwarding all calls to both handsets. Other implementations for insuring that PBX 102 has the appropriate information to forward the calls to the wireless network 105 may be utilized as well.

Continuing with the arriving call explanation, when a call arrives through a PBX 102 and a determination is made that the desktop phone to which the call is directed is associated with a user that has instructed such call to be forwarded to the wireless network, a call may be parked at the PBX 102 while a message is sent via mobile server 103 to the cell phone 104 over wireless network 105.

Optionally, the user of cell phone 104 may be required to accept the call in advance, and in response to such message. Assuming that such acceptance takes place, or that the system is configured to not require it, a wireless connection is established over commercial wireless network 105 between mobile server 103 and cell phone user 104. The wireless connection may be either over a wireless voice or a wireless data connection.

If the cell phone user is unavailable, the mobile server 103 will typically receive a voice message indicating so and offering voice mail. In accordance with the present invention, however, rather than be transferred into the voice mail of the cell phone as provided by wireless network 105, the mobile server 103 will detect that there is no live answer, and transfer the incoming call through IP-PBX 102 into the voicemail of the internal enterprise voice and data network 101. Thus, in all relevant respects, the caller believes that he or she has been simply been connected to the desktop telephone, and the use of the cell phone, even remotely over a commercial public wireless network, presents the same “face” to the caller as the internal enterprise voice and data network.

It is also noted that typically, there are certain functions that IP-PBX 102 provides to the desktop phone users over the internal voice and data network 101. These functions often include call forwarding, call blocking, etc. Typically, users configure their phone to implement one or more of these functions by pushing prescribed keys on their desktop telephones. For example, a user may enter the system to change his voicemail greeting message by pressing #6.

In accordance with the teachings of the present invention, when the cell phone 104 establishes a wireless link with the mobile server 103, the same functionality may be used by the cell phone. The cell phone may present a graphical user interface (GUI)or other interface to the user when in an appropriate mode to communicate wirelessly with the mobile server 103. The user may cause such mode to be implemented via a switch or other selectable option.

When in such mode, the user may use the keys to implement functions on the mobile phone just as those functions would be implemented by pushing keys on this desktop telephone set within the enterprise. The IP-PBX 102 will then interpret such keys as if they had been entered by the desktop telephone set.

Note that because the wireless device often has a graphical user interface, the user may have icons that represent the sequence of telephone keys that would normally be pushed. For example, suppose that the key sequence #6 is utilized to enter the voicemail system from the user's desktop. The user of cell phone 104, when in the appropriate mode, may enter #6, or alternatively may have an icon that simply says “enter voicemail system.” In response to selection of that icon, either the mobile server 103, or the cell phone 104, itself can translate that selection into the sequence of keys that represents #6 to the IP-PPX 102, so that PBX 102 can appropriately process the requested command just as if it had been entered from the desktop telephone set within the enterprise and connected to internal enterprise voice and data network 101.

With respect to the cell phone user out dialing, the mobile server 103 again acts as a proxy server in order to provide access to IP-PBX 102. The cell phone 104 may first send a call request message over the wireless data network 105 to mobile server 103, which translates the message into the appropriate signaling expected by IP-PBX 102 if the relevant desktop telephone on the internal voice and data network 101 were making the call. As a result, the caller identification shown to the called party will actually be the same as if the internal desktop telephone had made the call optionally however, the user may configure the system to display the actual cell phone number as well, although this may be undesirable in certain circumstances.

With respect to the data access portion of the invention, the system may work in a manner that is analogous to the voice portion. The wireless network 105 implements a wireless connection to mobile server 103. Mobile server 103 acts as a proxy and causes the wireless device to appear to IP-PBX 102 and to Internal enterprise network 101 as if the requested data access were coming from the internal desktop computer connected to internal enterprise voice/data network 101. Database access and other functions are then implemented as they would be from the desktop computer within the enterprise.

When a mobile user travels outside the home service area, it is possible for the user to buy a prepaid service to get wireless phone access. The prepaid service usually comes with a new local phone number and it is often very expensive or limited to long distance calling.

In such situations, the mobile user can inform the mobile server 103 of its new prepaid service number using the wireless Internet service. Thereafter, the system operates as previously described, wherein the mobile server 103 may bridge the cell phone to the in channel voice data network 101, using the newly supplied phone number.

Generally, in the preferred embodiment, the cell phone or other wireless device 104 uses a wireless data connection to connect to the mobile server 103, which acts as a proxy or gateway to interface to the IP-PBX 102. the IP-PBX 102 then preferably treats the wireless device as if it were the desktop telephone handset registered with the internal enterprise voice and data network 101. Thus, the wireless device 104 would have the same functionality as the normal desktop telephone handset.

While the forgoing describes the preferred embodiments of the invention, it is understood that various modifications and additions will be apparent to those skilled in the art. For example, the internal network 101 may be hard wired or wireless, and the wireless network 105 can be hardwired. In either event, the mobile server will make the external, remotely located device appear as if it were on the internal network as a registered device. Also, the mobile server 103 may be integrated with the IP-PBX 102. Further, the remote device 104 need not even be wireless, but can connect to the server 103 via a hard wired PSTN or data network.

These and other enhancements and variations are intended to be covered by the following claims.

1. A mobile server for connection to a private branch exchange (PBX), said mobile server including a processor for determining whether a call directed to an internal telephone is to be sent to remotely located wireless device instead, and software for presenting commands from said wireless device in a form that said commands appear to be from said internal telephone to said private branch exchange.

2. A mobile server according to claim 1 wherein said private branch exchange includes Internet Protocol (IP) capability.

3. A system including a PBX and mobile server, said system including plural interfaces to interface with internal telephone sets and computers that are registered on the internal network, and an interface to at least one public voice or data network to interface with at least one remote telephone or computer, and software for converting signals from said at least one remote telephone or computer such that said signals appear to the PBX to originate from at least one of said internal telephone sets or computers.

4. The system of claim 3 wherein the remote telephone computer communicates with the mobile server over a wireless network.

5. The system of claim 4 wherein incoming calls to an internal telephone are forwarded to a remote telephone, but if said remote telephone indicates a busy or no answer condition, said telephone calls are forwarded to a voice mail system registered on said internal network.

6. The system of claim 5 wherein said remote telephone is a wireless data device and wherein said wireless data device display icons that represent functions to be implemented in response to key input sequences on a telephone registered on said internal network.

7. The system of claim 6 wherein said mobile server translates a selection of an icon to a corresponding key sequence that implements a prescribed function in a PBX when entered from one of said telephones registered on said internal network.

8. A PBX connected to an internal network, a plurality of telephone sets registered with said internal network, said telephone sets being capable of causing the PBX to perform various functions via entry of various key sequences at the telephone sets, said PBX also having a public interface to the a public data network, said PBX also being configurable by a second phone, said second phone not registered on the internal network, via the various key sequences, wherein said second phone is connected to said internal network over a wireless data network, without placing a telephone call to become connected.

9. A method for accepting a call directed to a telephone set that is part of an internal enterprise network, said internal enterprise network having a voice mail system, said method comprising attempting to forward said call to a wireless device and doing so if said wireless device is available, said wireless device not being part of said internal enterprise network, but having its own associated network and voice mail system, and connecting said call to said voice mail system of said enterprise network if said wireless device is not answered by a user.

10. The method of claim 9 further comprising only forwarding said call in response to a command to do so previously entered by a user.

11. The method of claim 9 further comprising accepting icons selected at said wireless device and translating them to represent key sequences from an internal telephone set that represent commands to configure a PBX.
